(19) United States
(12) Patent Application Publication
(10) Pub. No.: US 2022/0383517 A1
(43) Pub. Date: Dec. 1, 2022

(54) METHOD AND DEVICE FOR TARGET TRACKING, AND STORAGE MEDIUM

(71) Applicant: SHANGHAI SENSETIME INTELLIGENT TECHNOLOGY CO., LTD., Shanghai (CN)

(72) Inventors: Jinghao ZHOU, Shanghai (CN); Lei QIAO, Shanghai (CN); Bo LI, Shanghai (CN)

(21) Appl. No.: 17/880,592

(22) Filed: Aug. 3, 2022

Related U.S. Application Data
(63) Continuation of application No. PCT/CN2021/100558, filed on Jun. 17, 2021.

(30) Foreign Application Priority Data
Mar. 18, 2021 (CN) 202110292542.0

(51) Int. Cl. G06T 7/246

(52) U.S. Cl. CPC G06T 7/248; G06T 2207/20084; G06T 2207/20221; G06T 2207/10016

(57) ABSTRACT

The present disclosure relates to a method and a device for target tracking, an electronic apparatus and a storage medium. The method comprises the following steps: obtaining a first tracking parameter from a template image of a target object; tracking the target object in a current image based on the first tracking parameter to obtain a first predicted tracking result of the current image; determining a second tracking parameter based on the template image and history images of the target object, wherein the history images represent images prior to the current image and containing the target object; tracking the target object in the current image based on the second tracking parameter to obtain a second predicted tracking result of the current image; and obtaining a tracking result of the target object in the current image based on the first predicted tracking result and the second predicted tracking result.

The present disclosure is a continuation of and claims priority to PCT Application. No. PCT/CN2021/100558, filed on Jun. 17, 2021, which is based upon and claims the benefit of a priority of Chinese Patent Application No. 202110292542.0, titled “Method and Device for Target Tracing, Electronic Apparatus, and Storage Medium” filed with the CNIPA on Mar. 18, 2021. All the above referenced priority documents are incorporated herein by reference.

### TECHNICAL FIELD

The present disclosure relates to the technical field of computer vision, in particular to a method and a device for target tracking, an electronic apparatus, and a storage medium.

### BACKGROUND

With the development of the image processing technology, the target tracking based on the image processing technology plays an increasingly important role in the fields of intelligent monitoring, automatic driving and image annotation, so the requirements for the target tracking have become higher.

In target tracking, an initial frame is usually given in a certain frame (for example, the first frame) of a video frame sequence to specify a target object to be tracked, and then the specified target object is tracked all the time. Because of interference such as blocking, illumination changes and scale changes, the target tracking has always been facing a big challenge.

### SUMMARY

The present disclosure provides a technical solution of target tracking.

An aspect of the present disclosure provides a target tracking method, comprising:

obtaining a first tracking parameter from a template image of a target object;

tracking the target object in a current image based on the first tracking parameter to obtain a first predicted tracking result of the current image;

determining a second tracking parameter based on the template image and history images of the target object, wherein the history images represent images prior to the current image and containing the target object;

tracking the target object in the current image based on the second tracking parameter to obtain a second predicted tracking result of the current image; and

obtaining a tracking result of the target object in the current image based on the first predicted tracking result and the second predicted tracking result.

In a possible implementation, obtaining the first tracking parameter from the template image of the target object comprises: extracting a first image feature of the template image as the first tracking parameter.

In a possible implementation, tracking the target object in the current image based on the first tracking parameter to obtain the first predicted tracking result of the current image comprises:

extracting a second image feature of the current image; and determining the first predicted tracking result of the current image based on the first tracking parameter and the second image feature.

In a possible implementation, extracting the first image feature of the template image as the first tracking parameter comprises:

extracting features of the template image through at least two layers with different depths of a first preset network, to obtain at least two levels of the first image feature of the template image, and taking the at least two levels of the first image feature as the first tracking parameter;

extracting the second image feature of the current image comprises: extracting features of the current image through the at least two layers with different depths to obtain at least two levels of the second image feature of the current image; and

determining the first predicted tracking result of the current image based on the first tracking parameter and the second image feature comprises: for any level of the at least two levels of the first image feature and the at least two levels of the second image feature, determining an intermediate predicted result of the level based on the first and second image features of the level; and based on at least two intermediate predicted results corresponding to the at least two levels of the first image feature and the at least two levels of the second image feature, obtaining the first predicted tracking result of the current image by fusion.

In a possible implementation, determining the second tracking parameter based on the template image and the history images of the target object comprises:

obtaining a third image feature of the template image;

determining an initial second tracking parameter based on the third image feature; and

obtaining an updated second tracking parameter based on the initial second tracking parameter and fourth image features of the history images.

In a possible implementation, determining the initial second tracking parameter based on the third image feature comprises:

initializing an online module of a second preset network based on the third image feature to obtain the initial second tracking parameter; and

obtaining the updated second tracking parameter based on the initial second tracking parameter and the fourth image features of the history images comprises: inputting the initial second tracking parameter and the fourth image features of the history images into the online module, and obtaining the updated second tracking parameter through the online module.

In a possible implementation, the history images are image areas extracted from history video frames in advance, and probabilities of the history images belonging to the target object are greater than or equal to a first threshold.

In a possible implementation, obtaining the third image feature of the template image comprises:

obtaining at least two levels of the first image feature of the template image and at least two first weights in one-to-one correspondence with the at least two levels of the first image feature; and

determining a weighted sum of the at least two levels of the first image feature based on the at least two first weights to obtain the third image feature of the template image.

In a possible implementation, tracking the target object in the current image based on the second tracking parameter to obtain the second predicted tracking result of the current image comprises:

obtaining a fifth image feature of the current image; and

determining the second predicted tracking result of the current image based on the second tracking parameter and the fifth image feature.

In a possible implementation, obtaining the fifth image feature of the current image comprises:

obtaining at least two levels of the second image feature of the current image and at least two second weights in one-to-one correspondence with the at least two levels of the second image feature; and

determining a weighted sum of the at least two levels of the second image feature based on the at least two second weights to obtain the fifth image feature of the current image.

In a possible implementation, obtaining the tracking result of the target object in the current image based on the first predicted tracking result and the second predicted tracking result comprises:

obtaining a third weight corresponding to the first predicted tracking result and a fourth weight corresponding to the second predicted tracking result;

determining a weighted sum of the first predicted tracking result and the second predicted tracking result based on the third weight and the fourth weight to obtain a third predicted tracking result of the current image; and

determining the tracking result of the target object in the current image based on the third predicted tracking result.

In a possible implementation, determining the tracking result of the target object in the current image based on the third predicted tracking result comprises:

determining a first bounding box with a highest probability of belonging to the target object in the current image, based on the third predicted tracking result;

determining a second bounding box having an overlapping region with the first bounding box in the current image, based on the third predicted tracking result; and

determining a detection box of the target object in the current image based on the first bounding box and the second bounding box.

In a possible implementation, determining the detection box of the target object in the current image based on the first bounding box and the second bounding box comprises:

determining Intersection-over-Union of the second bounding box and the first bounding box;

determining a fifth weight corresponding to the second bounding box, based on the Intersection-over-Union; and

determining a weighted sum of the first bounding box and the second bounding box based on the fifth weight, to obtain the detection box of the target object in the current image.

An aspect of the present disclosure provides a target tracking device, comprising:

an obtaining module configured to obtain a first tracking parameter from a template image of a target object;

a first target tracking module configured to track the target object in a current image based on the first tracking parameter to obtain a first predicted tracking result of the current image;

a determination module configured to determine a second tracking parameter based on the template image and history images of the target object, wherein the history images represent images prior to the current image and containing the target object;

a second target tracking module configured to track the target object in the current image based on the second tracking parameter to obtain a second predicted tracking result of the current image; and

a fusion module configured to obtain a tracking result of the target object in the current image based on the first predicted tracking result and the second predicted tracking result.

In a possible implementation, the obtaining module is configured to:

extract a first image feature of the template image as a first tracking parameter.

In a possible implementation, the first target tracking module is configured to:

extract a second image feature of the current image; and

determine a first predicted tracking result of the current image based on the first tracking parameter and the second image feature.

In one possible implementation,

the obtaining module is configured to extract features of the template image through at least two layers with different depths of a first preset network to obtain at least two levels of the first image feature of the template image, and take the at least two levels of the first image feature as the first tracking parameter; and

the first target tracking module is configured to extract features of the current image through the at least two layers with different depths to obtain at least two levels of the second image feature of the current image; for any level of the at least two levels of the first image feature and the at least two levels of the second image feature, determine an intermediate predicted result of the level based on the first and second image features of the level; and obtain the first predicted tracking result of the current image by fusion, based on at least two intermediate predicted results corresponding to the at least two levels of the first image feature and the at least two levels of the second image feature.

In a possible implementation, the determination module is configured to:

obtain a third image feature of the template image;

determine an initial second tracking parameter based on the third image feature; and

obtain an updated second tracking parameter based on the initial second tracking parameter and fourth image features of the history images.

In a possible implementation, the determination module is configured to:

initialize an online module of a second preset network based on the third image feature to obtain an initial second tracking parameter; and

input the initial second tracking parameter and the fourth image features of the history images into the online module to obtain an updated second tracking parameter through the online module.

In a possible implementation, the history images are image areas extracted from history video frames in advance, and probabilities of the history images belonging to the target object are greater than or equal to a first threshold.

In a possible implementation, the determination module is configured to:

obtain at least two levels of the first image feature of the template image and at least two first weights in a one-to-one correspondence with the at least two levels of the first image feature; and

determine a weighted sum of the at least two levels of the first image feature based on the at least two first weights to obtain a third image feature of the template image.

In a possible implementation, the second target tracking module is configured to:

obtain a fifth image feature of the current image; and

determine a second predicted tracking result of the current image based on the second tracking parameter and the fifth image feature.

In a possible implementation, the second target tracking module is configured to:

obtain at least two levels of the second image feature of the current image, and at least two second weights in a one-to-one correspondence with the at least two levels of the second image feature; and

determine a weighted sum of the at least two levels of the second image feature based on the at least two second weights to obtain a fifth image feature of the current image.

In a possible implementation, the fusion module is configured to:

obtain a third weight corresponding to the first predicted tracking result and a fourth weight corresponding to the second predicted tracking result;

determine a weighted sum of the first predicted tracking result and the second predicted tracking result based on the third weight and the fourth weight to obtain a third predicted tracking result of the current image; and

determine a tracking result of the target object in the current image base on the third predicted tracking result.

In a possible implementation, the fusion module is configured to:

determine a first bounding box with the highest probability of belonging to the target object in the current image based on the third predicted tracking result;

determine a second bounding box having an overlapping region with the first bounding box in the current image based on the third predicted tracking result; and

determine a detection box of the target object in the current image based on the first bounding box and the second bounding box.

In a possible implementation, the fusion module is configured to:

determine Intersection-over-Union of the second bounding box and the first bounding box;

determine a fifth weight corresponding to the second bounding box based on the Intersection-over-Union; and

determine a weighted sum of the first bounding box and the second bounding box based on the fifth weight to obtain the detection box of the target object in the current image.

According to an aspect of the present disclosure, there is provided an electronic apparatus, comprising: one or more processors; a memory for storing executable instructions, wherein the one or more processors are configured to call the executable instructions stored in the memory to execute the above method.

According to an aspect of the present disclosure, there is provided a computer-readable storage medium on which computer program instructions are stored, wherein the computer program instructions, when executed by a processor, implement the above method.

According to an aspect of the present disclosure, there is provided a computer program product including computer-readable code, or a nonvolatile computer-readable storage medium carrying the computer-readable code. When the computer-readable code is run in an electronic apparatus, a processor in the electronic apparatus executes the above method.

In the embodiment of the present disclosure, a first tracking parameter is obtained from a template image of a target object, and the target object is tracked in a current image based on the first tracking parameter to obtain a first predicted tracking result of the current image, so that a first predicted tracking result with relatively high accuracy can be obtained; a second tracking parameter is determined based on the template image and history images of the target object, and the target object is tracked in the current image based on the second tracking parameter to obtain a second predicted tracking result of the current image, so that a second predicted tracking result with relatively high robustness can be obtained by further referring to the information of the history images of the target object; and a tracking result of the target object in the current image is obtained based on the first predicted tracking result and the second predicted tracking result, thereby obtaining a tracking result with both accuracy and robustness. With the target tracking method provided by the embodiment of the present disclosure, the ability of discriminating between similar objects can be improved in the tracking process, so that the success rate of tracking the target object can be improved when there are interferences from similar objects.

It should be understood that the above general description and the following detailed description are exemplary and explanatory only, and are not intended to limit the present disclosure.

Other features and aspects of the present disclosure will become apparent from the following detailed description of exemplary embodiments with reference to the drawings.

### BRIEF DESCRIPTION OF THE DRAWINGS

The drawings described below are incorporated into and constitute a part of the description, and show the embodiments in line with the present disclosure. The drawings, together with the description, serve to explain the technical solution of the present disclosure.

FIG. 1 shows a flowchart of a target tracking method provided by an embodiment of the present disclosure.

FIG. 2 shows a schematic diagram of an application scenario provided by an embodiment of the present disclosure.

FIG. 3 shows a block diagram of a target tracking device provided by an embodiment of the present disclosure.

FIG. 4 shows a block diagram of an electronic apparatus 800 provided by an embodiment of the present disclosure.

FIG. 5 shows a block diagram of an electronic apparatus 1900 provided by an embodiment of the present disclosure.

### DETAILED DESCRIPTION OF THE EMBODIMENTS

Various exemplary embodiments, features and aspects of the present disclosure will be described in detail below with reference to the drawings. In the drawings, the same reference signs denote elements with the same or similar functions. Although various aspects of the embodiments are shown in the drawings, unless otherwise specified, the drawings are not necessarily drawn to scale.

The word “exemplary” used here means “serving as an example, embodiment or illustration”. Any embodiment described here as “exemplary” is not necessarily to be interpreted as superior to or better than other embodiments.

The term “and/or” used herein is only for describing an association relationship between the associated objects, which means that there may be three relationships, for example, A and/or B may denote three situations: A exists alone, both A and B exist, and B exists alone. Furthermore, the term “at least one of” herein means any one of a plurality of items or any combination of at least two of a plurality of items, for example, “including at least one of A, B and C” may imply including any one element or more elements selected from a set consisting of A, B and C.

Furthermore, for a better explanation of the present disclosure, numerous specific details are given in the following detailed description of the embodiments. Those skilled in the art should understand that the present disclosure may also be implemented without certain specific details. In some embodiments, methods, means, elements and circuits that are well known to those skilled in the art are not described in detail in order to highlight the main idea of the present disclosure.

In related technologies, the target tracking method usually completes the tracking and positioning of subsequent frames based on a template image of a first frame. This method is weak in discriminating between similar objects in the tracking process, and thus easily fails in the tracking when there are interferences from similar objects.

The embodiments of the present disclosure provide a method and a device for target tracking, an electronic apparatus and a storage medium. A first tracking parameter is obtained from a template image of a target object, and the target object is tracked in a current image based on the first tracking parameter to obtain a first predicted tracking result of the current image, so that a first predicted tracking result with relatively high accuracy can be obtained; a second tracking parameter is determined based on the template image and history images of the target object, and the target object is tracked in the current image based on the second tracking parameter to obtain a second predicted tracking result of the current image, so that a second predicted tracking result with relatively high robustness can be obtained by further referring to the information of the history images of the target object; and a tracking result of the target object in the current image is obtained based on the first predicted tracking result and the second predicted tracking result, thereby obtaining a tracking result with both accuracy and robustness. With the target tracking method provided by the embodiment of the present disclosure, the ability of discriminating between similar objects can be improved in the tracking process, so that the success rate of tracking the target object can be improved when there are interferences from similar objects.

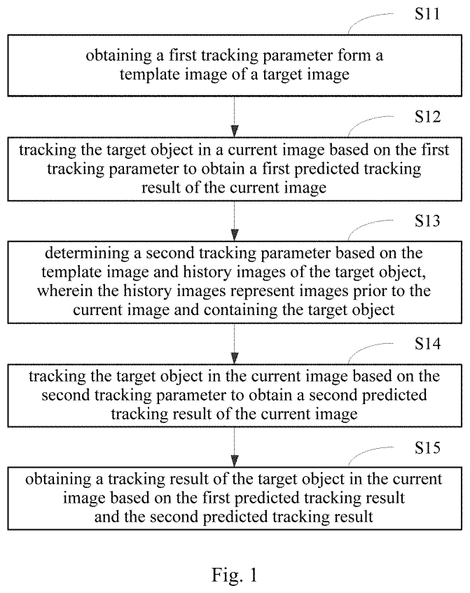

The following specifies the target tracking method provided by the embodiment of the present disclosure with reference to the drawings. FIG. 1 shows a flowchart of a target tracking method provided by an embodiment of the present disclosure. In a possible implementation, the target tracking method can be executed by a terminal device or a server or other processing devices, wherein the terminal device may be User Equipment (UE), a mobile device, a user terminal, a terminal, a cellular phone, a cordless telephone, a Personal Digital Assistant (PDA), a handheld device, a computing device, a vehicle-mounted device or a wearable device and the like. In some possible implementations, the target tracking method may be implemented by a processor calling a computer-readable instruction stored in a memory. As shown in FIG. 1, the target tracking method comprises steps S11 to S15.

In Step S11, a first tracking parameter is obtained from a template image of a target object.

In Step S12, the target object is tracked in a current image based on the first tracking parameter to obtain a first predicted tracking result of the current image.

In Step S13, a second tracking parameter is determined based on the template image and history images of the target object, wherein the history images represent images prior to the current image and containing the target object.

In Step S14, the target object is tracked in the current image based on the second tracking parameter to obtain a second predicted tracking result of the current image.

In Step S15, a tracking result of the target object in the current image is obtained based on the first predicted tracking result and the second predicted tracking result.

In the embodiment of the present disclosure, the target object may represent an object to be tracked. When there are a plurality of target objects, the target tracking method provided by the embodiment of the present disclosure can be executed for each target object. The type of the target object can be people, objects, animals or the like. The template image of the target object can be an image containing the target object. The template image of the target object may be an image of a specified area in a certain frame (for example, the first frame) of a target video, or it may not be an image in the target video. For example, an image in a specified area selected by the user in a first frame of a target video can be used as the template image of the target object. For another instance, an image in a specified area selected by the user in another video can be used as the template image of the target object. As yet another instance, an image uploaded or selected by the user can be used as the template image of the target object.

In the embodiment of the present disclosure, the first tracking parameter may represent a tracking parameter obtained from the template image. In the embodiment of the present disclosure, information can be extracted from the template image to obtain the first tracking parameter. That is, the first tracking parameter may contain the information of the template image. For example, the first tracking parameter may include at least one of feature information, color information, texture information and the like of the template image.

In a possible implementation, obtaining the first tracking parameter from the template image of the target object comprises extracting the first image feature of the template image as the first tracking parameter. In this implementation, the first image feature represents the image feature of the template image. In this implementation, the first image feature can be one level or at least two levels, and the first tracking parameter can include one level or at least two levels of the first image feature. In this implementation, by extracting the first image feature of the template image as the first tracking parameter, and tracking in the current image based on the first image feature of the template image, the accuracy of the determined first predicted tracking result can be improved.

In the embodiment of the present disclosure, the first predicted tracking result may represent a tracking result predicted in the current image based on the first tracking parameter. In the first predicted tracking result, a probability of each pixel in the current image belonging to the target object can be represented by a probability value, a heat value and the like.

In a possible embodiment, tracking the target object in the current image based on the first tracking parameter to obtain the first predicted tracking result of the current image comprises extracting a second image feature of the current image; and determining the first predicted tracking result of the current image based on the first tracking parameter and the second image feature. In this implementation, the second image feature represents the image feature of the current image. In this implementation, the second image feature can be one level or at least two levels. In this implementation, by determining the first predicted tracking result based on the first tracking parameter and the second image feature of the current image, the accuracy of the determined first predicted tracking result can be improved.

According to an example of this implementation, extracting the first image feature of the template image as the first tracking parameter comprises extracting features of the template image through at least two layers with different depths of a first preset network to obtain at least two levels of the first image feature of the template image, and taking the at least two levels of the first image feature as the first tracking parameter; extracting the second image feature of the current image comprises extracting features of the current image through at least two layers with different depths to obtain at least two levels of the second image feature of the current image; determining the first predicted tracking result of the current image based on the first tracking parameter and the second image feature comprises: for any level of the at least two levels of the first image feature and the at least two levels of the second image feature, determining an intermediate predicted result of the level based on the first and second image features of the level; and based on at least two intermediate predicted results corresponding to the at least two levels of the first image feature and the at least two levels of the second image feature, obtaining the first predicted tracking result of the current image by fusion.

In this example, the first preset network may be a twin network, for example, SiamRPN++. SiamRPN++ performs classification and positioning based on Region Proposal Network (RPN), which is beneficial to obtain more accurate positioning coordinates. For example, the first image feature can include three levels, namely, image feature of template image output by a block 2, a block 3 and a block 4 of SiamRPN++ respectively. The second image feature can include three levels, namely, image feature of current image output by a block 2, a block 3 and a block 4 of SiamRPN++ respectively. For example, at least two levels of the first image feature include a first image feature of a first level, a first image feature of a second level, and a first image feature of a third level, and at least two levels of the second image feature include a second image feature of a first level, a second image feature of a second level, and a second image feature of a third level. The first image feature of the first level and the second image feature of the first level can be convolved by a depthwise separable correlation layer to obtain an intermediate predicted result corresponding to the first level. The first image feature of the second level and the second image feature of the second level can be convolved by a depthwise separable correlation layer to obtain an intermediate predicted result corresponding to the second level. The first image feature of the third level and the second image feature of the third level can be convolved by a depthwise separable correlation layer to obtain an intermediate predicted result corresponding to the third level. Based on the intermediate predicted result corresponding to the first level, the intermediate predicted result corresponding to the second level and the intermediate predicted result corresponding to the third level, the first predicted tracking result of the current image can be obtained by fusion. In an example, before convolution of the first image feature of the second level and the second image feature of the second level, the first image feature of the second level and the second image feature of the second level can be interpolated to the same size as the first image feature of the first level and the second image feature of the first level; and before convolution of the first image feature of the third level and the second image feature of the third level, the first image feature of the third level and the second image feature of the third level can be interpolated to the same size as the first image feature of the first level and the second image feature of the first level. For example, the outputs of the block 3 and the block 4 of SiamRPN++ can be interpolated such that the size of a feature map obtained from the interpolation is the same as the size of a feature map output by the block 2, thereby enhancing the receptive field of the first preset network, and further improving the accuracy of target tracking by the first preset network.

In this example, a first predicted tracking result is determined by using at least two levels of a first image feature of a template image and at least two levels of a second image feature of a current image, and for any level of the at least two levels of the first image feature and the at least two levels of the second image feature, an intermediate predicted result of the level is determined based on the first image feature and the second image feature of the level. Based on at least two intermediate predicted results corresponding to the at least two levels of the first image feature and the at least two levels of the second image feature, the first predicted tracking result of the current image is obtained by fusion, such that richer image information of the template image and the current image can be utilized. Thus, while a potential area of the target object is being quickly and efficiently extracted from the current image, the interference information can be preliminarily filtered, the redundant calculation can be reduced, and the first image feature and the second image feature of the same level can be compared, thereby improving the accuracy of the first predicted tracking result.

In one example, a first predicted tracking result s_{θ}^{a}(y, xᵢ) of the current image can be determined by using Formula I:

$${s}_{θ}^{a} ( y , {x}_{i} ) = {\sum }_{l = 3}^{5} {α}^{l} ( {{ϕ}_{θ}^{l} ( z )}^{*} {ϕ}_{θ}^{l} ( {x}_{i} ) ) , \qquad Formula I$$

where z represents the template image, xᵢ represents the current image, ϕ_{θ}^{l}( ) represents an output of an l-th block of the first preset network, ϕ_{θ}^{l}(z) represents the first image feature of the template image z output from the l-th block of the first preset network after the template image z is input into the first preset network, and ϕ_{θ}^{l}(xᵢ) represents the second image feature of the current image xᵢ output from the l-th block of the first preset network after the current image xᵢ is input into the first preset network. For example, l=3 may correspond to a block 2 of SiamRPN++, l=4 may correspond to a block 3 of SiamRPN++, and l=5 may correspond to a block 4 of SiamRPN++. ϕ_{θ}^{l}(z)*ϕ_{θ}^{l}(xᵢ) represents a correlation between ϕ_{θ}^{l}(z) and ϕ_{θ}^{l}(xᵢ). In this example, the correlation between the first image feature and the second image feature of the same level can be used as the intermediate predicted result of this level. α^{l} represents the weight corresponding to ϕ_{θ}^{l}(z)*ϕ_{θ}^{l}(xᵢ) where α^{l} can be trained simultaneously with other parameters in the first preset network.

According to another example of this implementation, at least two levels of the first image feature can be fused to obtain a first fusion feature; at least two levels of the second image feature are fused to obtain a second fusion feature; and the first predicted tracking result of the current image is obtained based on the first fusion feature and the second fusion feature.

According to another example of this implementation, the first image feature of the template image and the second image feature of the current image may be one level, respectively, that is, the first predicted tracking result of the current image can be determined based on the first image feature of one level of the template image and the second image feature of one level of the current image.

In the embodiment of the present disclosure, the second tracking parameter may represent a tracking parameter determined based on the template image and the history images. In the embodiment of the present disclosure, the second tracking parameter may be determined based on the information of the template image and the history images. That is, the second tracking parameter may contain information of both the template image and the history images. In a possible implementation, the second tracking parameter can be determined based on the history images in a support set and the template image. In the process of target tracking, the history images in the support set can be updated, and correspondingly, the second tracking parameter can be updated in response to the update of the history images in the support set. In the embodiment of the present disclosure, by determining the second tracking parameter based on the template image and the history images, and tracking the target object in the current image based on the second tracking parameter, the ability of resisting interference from similar objects can be improved, and thus a second predicted tracking result with high robustness can be obtained. The second predicted tracking result may represent a tracking result predicted in the current image based on the second tracking parameter. In the second predicted tracking result, the probability of each pixel in the current image belonging to the target object can be represented by a probability value, a heat value or the like.

In a possible implementation, determining the second tracking parameter based on the template image and the history images of the target object comprises: obtaining a third image feature of the template image; determining an initial second tracking parameter based on the third image feature; and obtaining an updated second tracking parameter based on the initial second tracking parameter and fourth image features of the history images.

In this implementation, the third image feature is the image feature of the template image. For example, at least two levels of the first image feature of the template image can be fused to obtain the third image feature of the template image. For another example, the third image feature of the template image may be the same as the first image feature of the template image. In this implementation, the second tracking parameter can be determined based on the template image and each history image in the support set. The support set can be updated in the process of target tracking. For example, if the probability of any image area in the current image belonging to the target object is greater than or equal to a first threshold, the image area in the current image can be added to the support set as a new history image. In one example, the number of the history images in the support set is less than or equal to a second threshold. If the number of the history images in the support set exceeds the second threshold, the history image that is first added to the support set can be deleted. In this implementation, the template image is not included in the support set, that is, the second tracking parameter is also determined based on the information of the target object in the history images besides the template image. In this implementation, an initial value of the second tracking parameter may be the third image feature, and may be updated with the update of the history images.

In this implementation, by obtaining a third image feature of the template image, an initial second tracking parameter is determined based on the third image feature, and an updated second tracking parameter is obtained based on the initial second tracking parameter and fourth image features of the history images, the second tracking parameter can be continuously updated along with the update of the history images in the process of target tracking, thus enhancing the ability of resisting interference from similar objects.

According to an example of this implementation, determining the initial second tracking parameter based on the third image feature comprises initializing an online module of a second preset network based on the third image feature to obtain the initial second tracking parameter; and obtaining the updated second tracking parameter based on the initial second tracking parameter and the fourth image features of the history images comprises inputting the initial second tracking parameter and the fourth image features of the history images into the online module to obtain the updated second tracking parameter through the online module.

In this example, the second tracking parameter can be updated through the online module of the second preset network. For example, the initial second tracking parameter (i.e., the third image feature) and the fourth image features of the history images can be input into the online module to obtain the updated second tracking parameter. When the history images in the support set are updated, the current second tracking parameter and the fourth image feature of each history image in the current support set can be input into the online module to obtain the updated second tracking parameter. That is, the second tracking parameter can be updated in real time in response to the update of the history images in the support set. In this implementation, the online module of the second preset network is initialized based on the third image feature to obtain the initial second tracking parameter, and the initial second tracking parameter and the fourth image features of the history images are input into the online module to obtain the updated second tracking parameter through the online module, such that the second tracking parameter can be continuously updated through the online module of the second preset network along with the update of the history images in the process of target tracking, thereby strengthening the ability of resisting interference from similar objects.

According to an example of this implementation, the history images are image areas extracted from history video frames in advance, and the probabilities of the history images belonging to the target object are greater than or equal to a first threshold. In this example, the history video frames may represent video frames prior to the current image in the target video. In this example, the second tracking parameter is determined based on the template image and at least one history image, such that the information of the image area in the history image frame with a relatively high probability of belonging to the target object can be used to assist the target tracking in the current image, which is beneficial to obtain a second predicted tracking result with high robustness.

In an example, the support set can be represented as {(yⱼ, xⱼ)}ⱼ₌₁^{M}, where M represents the number of the history images in the support set, xⱼ represents the j-th history image in the support set, and yⱼ represents the pseudo label of xⱼ. The pseudo labels of the history images in the support set can be determined based on the Gaussian distribution of the probabilities of the respective positions in the history images belonging to the target object. In one example, the fourth image feature of each history image in the support set and the current second tracking parameter can be input into the online module, and a predicted probability of each history image belonging to the target object can be output via the online module. Based on the predicted probability of each history image belonging to the target object and the false label of each history image, a loss function corresponding to the second tracking parameter can be obtained. Based on the loss function, the second tracking parameter can be updated by a gradient descent method.

In an example, after training of the second preset network is completed, internal parameters of the second preset network may not be updated in the process of tracking the target object by using the second preset network, thereby improving the calculation efficiency.

According to an example of this implementation, obtaining the third image feature of the template image comprises: obtaining at least two levels of the first image feature of the template image and at least two first weights in a one-to-one correspondence with the at least two levels of the first image feature; and determining a weighted sum of the at least two levels of the first image feature based on the at least two first weights to obtain the third image feature of the template image. The second tracking parameter is determined based on the third image feature determined in this example, which can further improve the robustness of tracking the target object in the current image.

According to another example of this implementation, the third image feature can also be determined based on an average value of the at least two levels of the first image feature.

In a possible implementation, tracking the target object in the current image based on the second tracking parameter to obtain a second predicted tracking result of the current image comprises: obtaining a fifth image feature of the current image; and determining a second predicted tracking result of the current image based on the second tracking parameter and the fifth image feature. In this implementation, the fifth image feature is the image feature of the current image. For example, the fifth image feature and the second tracking parameter can be convolved in an up-channel manner by an up-channel correlation layer to obtain the second predicted tracking result. In this implementation, by determining the second predicted tracking result of the current image based on the second tracking parameter and the fifth image feature, the accuracy of the determined second predicted tracking result can be improved.

According to an example of this implementation, obtaining the fifth image feature of the current image comprises: obtaining at least two levels of the second image feature of the current image and at least two second weights in a one-to-one correspondence with the at least two levels of the second image feature; and determining a weighted sum of the at least two levels of the second image feature based on the at least two second weights to obtain the fifth image feature of the current image. Based on the fifth image feature determined in this example, the robustness of the second predicted tracking result can be further improved.

In an example, a second predicted tracking result s_{θ}^{r}(y, xᵢ) of the current image can be determined by using Formula II:

$${s}_{θ}^{r} ( y , {x}_{i} ) = {φ}^{*} {\sum }_{l = 3}^{5} {β}^{l} {ϕ}_{θ}^{l} ( {x}_{i} ) , \qquad Formula II$$

where φ represents the second tracking parameter, and ϕ_{θ}^{l}(xᵢ) represents the second image feature of the current image xᵢ output by an l-th block of the first preset network after the current image xᵢ is input into the first preset network. For example, l=3 may correspond to a block 2 of SiamRPN++, l=4 may correspond to a block 3 of SiamRPN++, and l=5 may correspond to a block 4 of SiamRPN++. β^{l} represents a weight corresponding to ϕ_{θ}^{l}( ). β^{l}ϕ_{θ}^{l}(xᵢ) represents that ϕ_{θ}^{l}(xᵢ) is weighted by β^{l}, and

$${\sum }_{l = 3}^{5} {β}^{l} {ϕ}_{θ}^{l} ( {x}_{i} )$$

represents a weighted sum of three levels of the second image feature extracted from the current image xᵢ by three blocks of the first preset network (three network blocks with different depths).

In an example, the second tracking parameter φ can be determined by using Formula III:

$$φ = Λ ( {\sum }_{l = 3}^{5} {β}^{l} {ϕ}_{θ}^{l} ( z ) , {\{ ( â ( y , {y}_{j} ) , {\sum }_{l = 3}^{5} {β}^{l} {ϕ}_{θ}^{l} ( {x}_{j} ) ) \}}_{j = 1}^{M} ; ρ ) , \qquad Formula III$$

where

$${\{ ( \hat{a} ( y , {y}_{j} ) , {{\sum }_{l = 3}}^{5} {β}^{l} {ϕ}_{θ}^{l} ( {x}_{j} ) ) \}}_{j = 1}^{M}$$

represents the support set. The support set comprises M history images, xⱼ represents a j-th history image in the support set, and â(y, yⱼ) represents the pseudo label of xⱼ. ϕ_{θ}^{l}(xⱼ) represents the sixth image feature of the history image xⱼ output by the l-th block of the first preset network after the history image xⱼ is input into the first preset network. β^{l} represents a weight corresponding to ϕ_{θ}^{l}( ). β^{l}ϕ_{θ}^{l}(xⱼ) represents that ϕ_{θ}^{l}(xⱼ) is weighted by

$${β}^{l} . {{\sum }_{l = 3}}^{5} {β}^{l} {ϕ}_{θ}^{l} ( {x}_{j} )$$

represents a weighted sum of three levels of the sixth image feature extracted from the history image xⱼ by three blocks of the first preset network, namely, the fourth image feature of the history image xⱼ. Λ represents the online module, and ρ represents the internal parameters of the online module. With the update of the history images in the support set, the second tracking parameter φ will be updated. In one example, the fourth image features of the M history images in the support set and the current second tracking parameter can be input into the online module Λ, and a predicted probability of each history image belonging to the target object can be output via the online module Λ. Based on the predicted probability of each history image belonging to the target object and the pseudo label â(y, yⱼ) of each history image, a loss function corresponding to the second tracking parameter can be obtained. Based on the loss function, the second tracking parameter can be updated by a gradient descent method to obtain an updated second tracking parameter.

In a possible implementation, obtaining the tracking result of the target object in the current image based on the first predicted tracking result and the second predicted tracking result comprises: obtaining a third weight corresponding to the first predicted tracking result and a fourth weight corresponding to the second predicted tracking result; determining a weighted sum of the first predicted tracking result and the second predicted tracking result based on the third weight and the fourth weight to obtain a third predicted tracking result of the current image; and determining a tracking result of the target object in the current image based on the third predicted tracking result. In this implementation, the third weight and the fourth weight can be hyperparameters, respectively. The sum of the third weight and the fourth weight may be equal to 1, the third weight may be greater than 0 and less than 1, and the fourth weight may be greater than 0 and less than 1. Undoubtedly, the sum of the third weight and the fourth weight may not be equal to 1. In this implementation, the third predicted tracking result can be determined based on the weighted sum of the first predicted tracking result and the second predicted tracking result. In this implementation, by determining the weighted sum of the first predicted tracking result and the second predicted tracking result based on the third weight and the fourth weight, the third predicted tracking result of the current image is obtained, and the tracking result of the target object in the current image is determined based on the third predicted tracking result, such that the obtained tracking result of the target object in the current image can be both accurate and robust.

In an example, a tracking result ŝ_{θ}(y, xᵢ) of the target object in the current image can be determined by using Formula IV:

ŝ_{θ}(y,xᵢ)=μs_{θ}^{r}(y,xᵢ)+(1−μ)s_{θ}^{a}(y,xᵢ) Formula IV,

where s_{θ}^{r}(y, xᵢ) represents the second predicted tracking result, μ represents the fourth weight corresponding to the second predicted tracking result, s_{θ}^{a}(y, xᵢ) represents the first predicted tracking result, and 1−μ represents the third weight corresponding to the first predicated tracking result.

According to an example of this implementation, determining the tracking result of the target object in the current image based on the third predicted tracking result comprises: determining a first bounding box with the highest probability of belonging to the target object in the current image based on the third predicted tracking result; determining a second bounding box having an overlapping region with the first bounding box in the current image based on the third predicted tracking result; and determining a detection box of the target object in the current image based on the first bounding box and the second bounding box. In this example, bounding box regression can be performed based on the third predicted tracking result to obtain a plurality of candidate boxes of the target object in the current image. Among the candidate boxes, a candidate box with the highest probability of belonging to the target object can be taken as a first bounding box, and a candidate box having an overlapping region with the first bounding box can be taken as a second bounding box. The number of the second bounding boxes can be one or more. In this example, when determining the detection box of the target object in the current image, the determination is based not only on the first bounding box with the highest probability of belonging to the target object, but also on the second bounding box having an overlapping region with the first bounding box, such that more information of the candidate boxes can be used to obtain a more accurate detection frame.

In one example, determining the detection box of the target object in the current image based on the first bounding box and the second bounding box comprises: determining Intersection-over-Union of the second bounding box and the first bounding box; determining a fifth weight corresponding to the second bounding box based on the Intersection-over-Union; and determining a weighted sum of the first bounding box and the second bounding box based on the fifth weight to obtain the detection box of the target object in the current image. For example, the weight corresponding to the first bounding box may be 1, and the fifth weight corresponding to any second bounding box may be equal to the Intersection-over-Union of the second bounding box and the first bounding box. For another example, the weight corresponding to the first bounding box may be positively correlated with the probability of the first bounding box belonging to the target object; and the fifth weight corresponding to any second bounding box can be positively correlated with the Intersection-over-Union of the second bounding box and the first bounding box, and is positively correlated with the probability of the second bounding box belonging to the target object. For example, the weight corresponding to the first bounding box may be the probability of the first bounding box belonging to the target object; and the fifth weight corresponding to any second bounding box can be equal to a product of the Intersection-over-Union of the second bounding box and the first bounding box and the probability of the second bounding box belonging to the target object. For example, a weighted sum of the first bounding box and the respective second bounding boxes can be determined; a sum of the weight corresponding to the first bounding box and the fifth weights corresponding to the respective second bounding boxes is determined to obtain a sum of the weights; and a ratio of the weighted sum to the sum of the weights is used as the detection box of the target object in the current image. In the above example, by determining the Intersection-over-Union of the second bounding box and the first bounding box, the fifth weight corresponding to the second bounding box is determined based on the Intersection-over-Union, and the weighted sum of the first bounding box and the second bounding box is determined based on the fifth weight to obtain the detection box of the target object in the current image, thereby improving the stability of the tracking result.

In another example, the fifth weights corresponding to the respective second bounding boxes may be the same. For example, an average value of the respective second bounding boxes can be calculated, and this average value and an average value of the first bounding box can be used as the detection box of the target object in the current image.

Undoubtedly, in other examples, the first bounding box can be directly used as the detection box of the target object.

In the embodiment of the present disclosure, the first tracking parameter is obtained from the template image of the target object, and the target object is tracked in the current image based on the first tracking parameter to obtain the first predicted tracking result of the current image, such that the first predicted tracking result with relatively high accuracy can be obtained; the second tracking parameter is determined based on the template image and the history images of the target object, and the target object is tracked in the current image based on the second tracking parameter to obtain the second predicted tracking result of the current image, such that the second predicted tracking result with relatively high robustness can be obtained by further referring to the information of the history images of the target object; and the tracking result of the target object in the current image is obtained based on the first predicted tracking result and the second predicted tracking result, thereby obtaining the tracking result with both accuracy and robustness. With the target tracking method provided by the embodiment of the present disclosure, the ability of discriminating between similar objects can be improved in the tracking process, such that the success rate of tracking the target object can be improved when there are interferences from similar objects.

The target tracking method provided by the embodiment of the present disclosure can be applied to tracking tasks such as single target tracking or multi-target tracking.

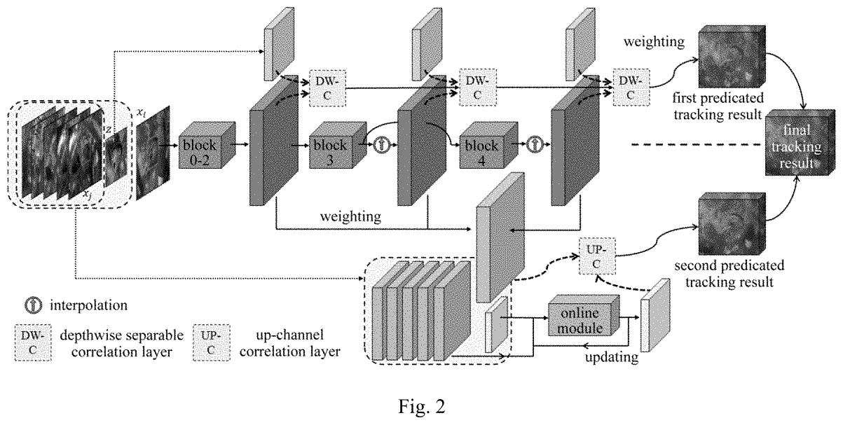

The following describes the target tracking method provided by the embodiment of the present disclosure through a specific application scenario. FIG. 2 shows a schematic diagram of an application scenario provided by the embodiment of the present disclosure. As shown in FIG. 2, this application scenario provides a target tracker, which comprises a first preset network and a second preset network, wherein the second preset network comprises an online module. An input of the first preset network can be the template image z of the target object and the current image xᵢ, and an output can be the first predicted tracking result s_{θ}^{a}(y, xᵢ). An input of the second preset network can be the third image feature of the template image z, the fourth image features of the respective history images xⱼ in the support set and the fifth image feature of the current image xᵢ, and an output can be the second predicted tracking result s_{θ}^{r}(y, xᵢ). A weighted sum of the first predicted tracking result s_{θ}^{a}(y, xᵢ) and the second predicted tracking result s_{θ}^{r}(y, xᵢ) is calculated to obtain a final tracking result of the target object in the current image xᵢ. The first preset network and the second preset network are introduced below.

The first preset network may adopt SiamRPN++. The template image z is input into SiamRPN++, and a first image feature of a first level, a first image feature of a second level and a first image feature of a third level of the template image z can be respectively output via a block 2, a block 3 and a block 4 of SiamRPN++. By inputting the current image xᵢ into SiamRPN++, a second image feature of a first level, a second image feature of a second level and a second image feature of a third level of the current image xᵢ can be respectively output via the block 2, the block 3 and the block 4 of SiamRPN++. Correlation between the first image feature of the first level and the second image feature of the first level can be calculated by a depthwise separable correlation layer (DW-C) to obtain an intermediate predicted result corresponding to the first level. Correlation between the first image feature of the second level and the second image feature of the second level can be calculated by the depthwise separable correlation layer to obtain an intermediate predicted result corresponding to the second level. Correlation between the first image feature of the third level and the second image feature of the third level can be calculated by the depthwise separable correlation layer to obtain an intermediate predicted result corresponding to the third level. A weighted sum of the intermediate predicted results of the three levels is calculated to obtain a first predicted tracking result. As shown in FIG. 2, the outputs of the block 3 and the block 4 of SiamRPN++ can also be interpolated, such that a size of a feature map obtained from the interpolation is the same as a size of a feature map output by the block 2, thereby enhancing the receptive field of the first preset network, and further improving the accuracy of target object tracking by the first preset network. A first predicted tracking result with high accuracy can be obtained by using the first preset network, that is, the accuracy of the position of the target object obtained by regression of the first preset network is high.

The online module of the second preset network can be used to update the second tracking parameter, wherein an initial value of the second tracking parameter may be the third image feature of the template image z. When the second tracking parameter is updated for the first time, the third image feature of the template image z and the fourth image features of the history images in the support set can be input into the online module to obtain an updated second tracking parameter. When the second tracking parameter is subsequently updated, the current second tracking parameter and the fourth image features of the respective history images in the support set can be input into the online module to obtain an updated second tracking parameter. Correlation between the fifth image feature of the current image xᵢ and the latest second tracking parameter can be calculated by an up-channel correlation (UP-C) layer to obtain a second predicted tracking result. By using the second preset network, a second predicted tracking result with high robustness can be obtained, that is, the second preset network has high robustness for classification and a strong ability for resisting interferences from similar objects.

Based on the first predicted tracking result and the second predicted tracking result, a tracking result of the target object in the current image can be obtained, thereby obtaining a tracking result with both accuracy and robustness. For example, when there are one or more interfering objects (i.e., objects similar to the target object) around the target object, by adopting the target tracking method provided by the embodiment of the present disclosure, the interfering objects and the target object can be accurately distinguished, so the tracking result can be more accurate. For another example, in a unmanned aerial vehicle tracking shooting system, the target object may be blocked by pavilions, bridges, buildings, etc., and when the target object appears again, by adopting the target tracking method provided by the embodiment of the present disclosure, the target object can be found again accurately and efficiently. For another example, the target tracking method provided by the embodiment of the present disclosure can also be applied to automatic labeling, thereby obtaining more accurate automatic labeling data. In addition, the target tracking method provided by the embodiment of the present disclosure has relatively high classification accuracy and regression accuracy, relatively high stability, better adaptability to long-term target tracking tasks, relatively fast tracking speed, and can achieve real-time tracking.

It can be understood that all the above method embodiments mentioned in the present disclosure can be combined with each other to form combined embodiments without violating the principle and logic, which will not be repeated here due to the limitation of space. It can be understood by those skilled in the art that in the above methods of the specific embodiments, the specific execution sequence of the respective steps should be determined by their functions and possible internal logic.

In addition, the present disclosure further provides a target tracking device, an electronic apparatus, a computer-readable storage medium, and a program, all of which can be used to implement any of the target tracking methods provided by the present disclosure. The corresponding technical solutions and technical effects can be found in the corresponding disclosure in the method section, and thus are not repeated here.

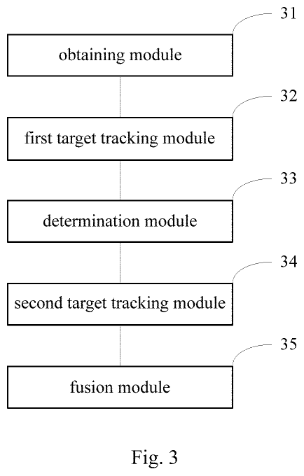

FIG. 3 shows a block diagram of a target tracking device provided by an embodiment of the present disclosure. As shown in FIG. 3, the target tracking device comprises:

an obtaining module 31 configured to obtain a first tracking parameter from a template image of a target object;

a first target tracking module 32 configured to track the target object in a current image based on the first tracking parameter to obtain a first predicted tracking result of the current image;

a determination module 33 configured to determine a second tracking parameter based on the template image and history images of the target object, wherein the history images represent images prior to the current image and containing the target object;

a second target tracking module 34 configured to track the target object in the current image based on the second tracking parameter to obtain a second predicted tracking result of the current image; and

a fusion module 35 configured to obtain a tracking result of the target object in the current image based on the first predicted tracking result and the second predicted tracking result.

In a possible implementation, the obtaining module 31 is configured to:

extract a first image feature of the template image as a first tracking parameter.

In a possible implementation, the first target tracking module 32 is configured to:

extract a second image feature of the current image; and

determine a first predicted tracking result of the current image based on the first tracking parameter and the second image feature.

In one possible implementation,

the obtaining module 31 is configured to extract features of the template image through at least two layers with different depths of a first preset network to obtain at least two levels of the first image feature of the template image, and take the at least two levels of the first image feature as the first tracking parameter; and

the first target tracking module 32 is configured to extract features of the current image through the at least two layers with different depths to obtain at least two levels of the second image feature of the current image; for any level of the at least two levels of the first image feature and the at least two levels of the second image feature, determine an intermediate predicted result of the level based on the first and second image features of the level; and obtain the first predicted tracking result of the current image by fusion, based on at least two intermediate predicted results corresponding to the at least two levels of the first image feature and the at least two levels of the second image feature.

In a possible implementation, the determination module 33 is configured to:

determine an initial second tracking parameter based on the third image feature; and

obtain an updated second tracking parameter based on the initial second tracking parameter and fourth image features of the history images.

In a possible implementation, the determination module 33 is configured to:

initialize an online module of a second preset network based on the third image feature to obtain the initial second tracking parameter; and

input the initial second tracking parameter and the fourth image features of the history images into the online module to obtain an updated second tracking parameter through the online module.

In a possible implementation, the history images are image areas intercepted from history video frames in advance, and probabilities of the history images belonging to the target object are greater than or equal to a first threshold.

In a possible implementation, the determination module 33 is configured to:

obtain at least two levels of the first image feature of the template image and at least two first weights in a one-to-one correspondence with the at least two levels of the first image feature; and

determine a weighted sum of the at least two levels of the first image feature based on the at least two first weights to obtain a third image feature of the template image.

In a possible implementation, the second target tracking module 34 is configured to:

obtain a fifth image feature of the current image; and

determine a second predicted tracking result of the current image based on the second tracking parameter and the fifth image feature.

In a possible implementation, the second target tracking module 34 is configured to:

obtain at least two levels of the second image feature of the current image, and at least two second weights in a one-to-one correspondence with the at least two levels of the second image feature; and

determine a weighted sum of the at least two levels of the second image feature based on the at least two second weights to obtain a fifth image feature of the current image.

In a possible implementation, the fusion module 35 is configured to:

obtain a third weight corresponding to the first predicted tracking result and a fourth weight corresponding to the second predicted tracking result;

determine a weighted sum of the first predicted tracking result and the second predicted tracking result based on the third weight and the fourth weight to obtain a third predicted tracking result of the current image; and

determine a tracking result of the target object in the current image base on the third predicted tracking result.

In a possible implementation, the fusion module 35 is configured to:

determine a first bounding box with the highest probability of belonging to the target object in the current image based on the third predicted tracking result;

determine a second bounding box having an overlapping region with the first bounding box in the current image based on the third predicted tracking result; and

determine a detection box of the target object in the current image based on the first bounding box and the second bounding box.

In a possible implementation, the fusion module 35 is configured to:

determine Intersection-over-Union of the second bounding box and the first bounding box;

determine a fifth weight corresponding to the second bounding box based on the Intersection-over-Union; and

determine a weighted sum of the first bounding box and the second bounding box based on the fifth weight to obtain a detection box of the target object in the current image.

In the embodiment of the present disclosure, the first tracking parameter is obtained from the template image of the target object, and the target object is tracked in the current image based on the first tracking parameter to obtain the first predicted tracking result of the current image, such that the first predicted tracking result with relatively high accuracy can be obtained; the second tracking parameter is determined based on the template image and the history images of the target object, and the target object is tracked in the current image based on the second tracking parameter to obtain the second predicted tracking result of the current image, such that the second predicted tracking result with relatively high robustness can be obtained by further referring to the information of the history images of the target object; and the tracking result of the target object in the current image is obtained based on the first predicted tracking result and the second predicted tracking result, thereby obtaining the tracking result with both accuracy and robustness. With the target tracking method provided by the embodiment of the present disclosure, the ability of discriminating between similar objects can be improved in the tracking process, such that the success rate of tracking the target object can be improved when there are interferences from similar objects.

In some embodiments, the functions or the modules of the devices provided by the embodiments of the present disclosure can be used to execute the methods described in the above method embodiments, and the specific implementation and technical effects can be found in the above description of the method embodiments, which will not be repeated here for brevity.

An embodiment of the present disclosure also provides a computer-readable storage medium, on which computer program instructions are stored. The computer program instructions, when executed by a processor, implement the above method. The computer-readable storage medium may be a nonvolatile computer-readable storage medium or a volatile computer-readable storage medium.

An embodiment of the present disclosure also provides a computer program including computer-readable code, and when the computer-readable code is run in an electronic apparatus, a processor in the electronic apparatus executes the above method.

An embodiment of the present disclosure also provides a computer program product, comprising computer-readable code or a nonvolatile computer-readable storage medium carrying computer-readable code, wherein when the computer-readable code is executed in an electronic apparatus, a processor in the electronic apparatus implements the above method.

An embodiment of the present disclosure also provides an electronic apparatus, comprising one or more processors; and a memory for storing executable instructions, wherein the one or more processors are configured to call the executable instructions stored in the memory to execute the above method.

The electronic apparatus may be provided as a terminal, a server, or apparatuses in other forms.

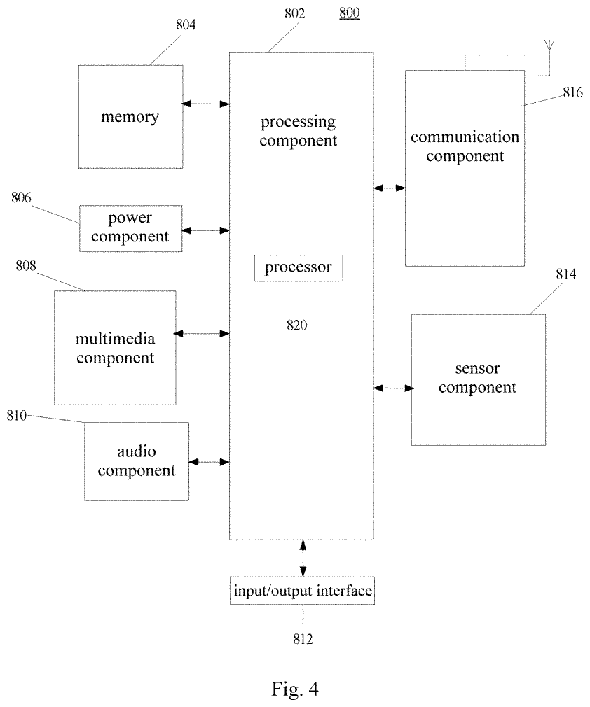

FIG. 4 shows a block diagram of an electronic apparatus 800 provided by an embodiment of the present disclosure. For example, the electronic apparatus 800 may be a mobile phone, a computer, a digital broadcast terminal, a message transceiver, a game console, a tablet device, medical equipment, fitness equipment, a Personal Digital Assistant (PDA), or any other terminal.

Referring to FIG. 4, the electronic apparatus 800 may comprise one or more of the following components: a processing component 802, a memory 804, a power supply component 806, a multimedia component 808, an audio component 810, an input/output (I/O) interface 812, a sensor component 814, and a communication component 816.

The processing component 802 generally controls the overall operation of the electronic apparatus 800, such as operations related to display, phone call, data communication, camera operation, and record operation. The processing component 802 may comprise one or more processors 820 to execute instructions so as to complete all or some steps of the above method. Furthermore, the processing component 802 may comprise one or more modules for facilitating interaction between the processing component 802 and other components. For example, the processing component 802 may comprise a multimedia module to facilitate the interaction between the multimedia component 808 and the processing component 802.

The memory 804 is configured to store various types of data to support the operations of the electronic apparatus 800. Examples of these data include instructions for any application or method operated on the electronic apparatus 800, contact data, telephone directory data, messages, pictures, videos, etc. The memory 804 may be implemented by any type of volatile or non-volatile storage apparatuses or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk, or a compact disk.

The power supply component 806 supplies electric power to various components of the electronic apparatus 800. The power supply component 806 may comprise a power supply management system, one or more power supplies, and other components related to the generation, management, and allocation of power for the electronic apparatus 800.

The multimedia component 808 comprises a screen providing an output interface between the electronic apparatus 800 and a user. In some embodiments, the screen may comprise a Liquid Crystal Display (LCD) and a Touch Panel (TP). If the screen comprises the touch panel, the screen may be implemented as a touch screen to receive an input signal from the user. The touch panel comprises one or more touch sensors to sense the touch, sliding and gestures on the touch panel. The touch sensor may not only sense a boundary of the touch or sliding operation, but also detect the duration and pressure related to the touch or sliding operation. In some embodiments, the multimedia component 808 comprises a front camera and/or a rear camera. When the electronic apparatus 800 is in an operating mode such as a shooting mode or a video mode, the front camera and/or the rear camera may receive external multimedia data. Each front camera and rear camera may be a fixed optical lens system or have a focal length and optical zooming capacity.

The audio component 810 is configured to output and/or input an audio signal. For example, the audio component 810 comprises a microphone (MIC). When the electronic apparatus 800 is in the operating mode such as a call mode, a record mode and a voice identifying mode, the microphone is configured to receive an external audio signal. The received audio signal may be further stored in the memory 804 or sent by the communication component 816. In some embodiments, the audio component 810 also comprises a loudspeaker which is configured to output the audio signal.

The I/O interface 812 provides an interface between the processing component 802 and a peripheral interface module. The peripheral interface module may be a keyboard, a click wheel, buttons, etc. These buttons may include, but are not limited to: a home button, a volume button, a start button, and a lock button.

The sensor component 814 comprises one or more sensors which are configured to provide state evaluation in various aspects for the electronic apparatus 800. For example, the sensor component 814 may detect an on/off state of the electronic apparatus 800 and relative positions of the components such as a display and a keypad of the electronic apparatus 800. The sensor component 814 may also detect the position change of the electronic apparatus 800 or a component of the electronic apparatus 800, presence or absence of a user contact with the electronic apparatus 800, directions or acceleration/deceleration of the electronic apparatus 800 and the temperature change of the electronic apparatus 800. The sensor component 814 may include a proximity sensor configured to detect the presence of nearby objects without physical contact. The sensor component 814 may further comprise an optical sensor, such as a Complementary Metal Oxide Semiconductor (CMOS) or Charge Coupled Device (CCD) image sensor, for use in the imaging application. In some embodiments, the sensor component 814 may further comprise an acceleration sensor, a gyroscope sensor, a magnetic sensor, a pressure sensor or a temperature sensor.

The communication component 816 is configured to facilitate the communication in a wired or wireless mode between the electronic apparatus 800 and other apparatuses. The electronic apparatus 800 may access a wireless network based on communication standards, such as wireless fidelity (Wi-Fi), a 2^{nd} generation mobile communication technology (2G), a 3^{rd} generation mobile communication technology (3G), a 4^{th} generation mobile communication technology (4G), Long Term Evolution (LTE) of the mobile communication technology, a 5^{th} generation mobile communication technology (5G), or a combination thereof. In an exemplary embodiment, the communication component 816 receives a broadcast signal or broadcast related information from an external broadcast management system via a broadcast channel. In an exemplary embodiment, the communication component 816 further comprises a Near Field Communication (NFC) module to promote the short range communication. For example, the NFC module may be implemented on the basis of a Radio Frequency Identification (RFID) technology, an Infrared Data Association (IrDA) technology, an Ultra Wide Band (UWB) technology, a Bluetooth (BT) technology and other technologies.

In an exemplary embodiment, the electronic apparatus 800 can be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors, or other electronic components, and is used to execute the above method.

In an exemplary embodiment, there is further provided a non-volatile computer-readable memory medium, such as the memory 804 including computer program instructions. The computer program instructions may be executed by the processor 820 of the electronic apparatus 800 to implement the above method.

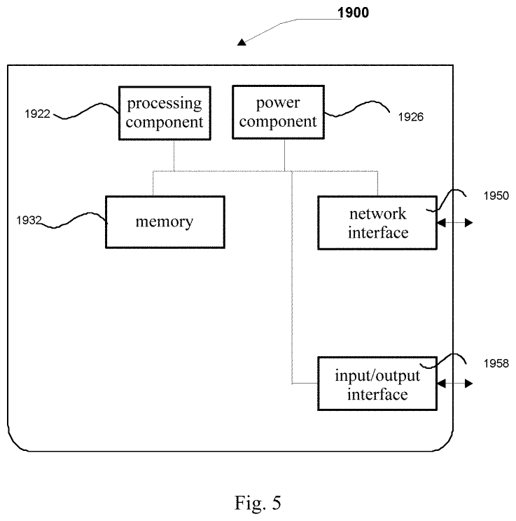

FIG. 5 shows a block diagram of an electronic apparatus 1900 provided by an embodiment of the present disclosure. For example, the electronic apparatus 1900 can be provided as a server. Referring to FIG. 5, the electronic apparatus 1900 comprises a processing component 1922, which further comprises one or more processors, and a memory resource represented by a memory 1932 for storing instructions executable by the processing component 1922, such as application programs. The application program stored in the memory 1932 may include one or more modules each corresponding to a set of instructions. In addition, the processing component 1922 is configured to execute instructions to execute the above method.

The electronic apparatus 1900 may further comprise a power component 1926 configured to perform power management of the apparatus 1900, a wired or wireless network interface 1950 configured to connect the electronic apparatus 1900 to a network, and an input/output (I/O) interface 1958. The apparatus 1900 can operate based on an operating system stored in the memory 1932, such as Windows Server™, Mac OS X™, Unix™, Linux™, FreeBSD™ or the like.

In an exemplary embodiment, a non-transitory computer readable storage medium is further provided, such as the memory 1932 including computer program instructions, which can be executed by the processing component 1922 of the apparatus 1900 to implement the above-described method.

The present disclosure may be implemented by a system, a method, and/or a computer program product. The computer program product may include a computer readable storage medium having computer-readable program instructions for causing a processor to carry out various aspects of the present disclosure stored thereon.

The computer-readable storage medium can be a tangible device that can hold and store instructions used by an instruction functioning as a device. The computer-readable storage medium may be, but is not limited to, e.g., electronic storage device, magnetic storage device, optical storage device, electromagnetic storage device, semiconductor storage device, or any proper combination thereof. More specific examples (a non-exhaustive list) of the computer-readable storage medium include: a portable computer disk, hard disk, random access memory (RAM), read-only memory (ROM), erasable programmable read-only memory (EPROM or Flash memory), static random access memory (SRAM), portable compact disc read-only memory (CD-ROM), digital versatile disk (DVD), memory stick, floppy disk, mechanically encoded device (for example, punch-cards or raised structures in a groove having instructions recorded thereon), and any proper combination thereof. The computer-readable storage medium used herein should not be construed as transitory signal per se, such as radio waves or other electromagnetic waves which propagate freely, electromagnetic waves propagating through a waveguide or other transmission media (e.g., light pulses propagating through a fiber-optic cable), or electrical signals transmitted through a wire.

Computer-readable program instructions described herein can be downloaded to individual computing/processing devices from a computer-readable storage medium or to an external computer or external storage device via a network, for example, the Internet, local area network, wide area network and/or wireless network. The network may comprise copper transmission cables, optical fiber transmission, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium in the respective computing/processing devices.

Computer program instructions for carrying out the operations of the present disclosure may be assembly instructions, instruction-set-architecture (ISA) instructions, machine instructions, machine-related instructions, microcode, firmware instructions, state-setting data, or source code or object code written in any combination of one or more programming languages. The programming languages include object-oriented programming languages, such as Smalltalk, C++ or the like, and the conventional procedural programming languages, such as the “C” programming language or similar programming languages.

The computer-readable program instructions may be executed entirely on a user's computer, partly on a user's computer, as a stand-alone software package, partly on a user's computer and partly on a remote computer, or entirely on a remote computer or a server. In a scenario involving a remote computer, the remote computer may be connected to the user's computer through any type of network, including local area network (LAN) or wide area network (WAN), or connected to an external computer (for example, using an Internet Service Provider to connect through the Internet). In some embodiments, electronic circuitry, such as programmable logic circuitry, field-programmable gate arrays (FPGA), or programmable logic arrays (PLA), may be customized by using state information of the computer-readable program instructions; and the electronic circuitry may execute the computer-readable program instructions, so as to achieve various aspects of the present disclosure.

Aspects of the present disclosure have been described herein with reference to the flowchart and/or the block diagrams of the method, device (systems), and computer program product according to the embodiments of the present disclosure. It will be appreciated that each block in the flowchart and/or the block diagram, and combinations of blocks in the flowchart and/or block diagram, can be implemented by the computer-readable program instructions.

These computer-readable program instructions may be provided to a processor of a general purpose computer, a dedicated computer, or other programmable data processing devices, to form a machine, such that when the instructions are executed by the processor of the computer or other programmable data processing devices, the machine implements the functions/actions specified in one or more blocks in the flowchart and/or block diagram. These computer-readable program instructions may also be stored in a computer-readable storage medium, and the instructions cause the computer, programmable data processing device and/or other devices to function in a particular manner, such that the computer-readable storage medium having instructions stored thereon comprises a product that includes instructions implementing aspects of the functions/actions specified in one or more blocks in the flowchart and/or block diagram.

The computer-readable program instructions may also be loaded into a computer, other programmable data processing devices, or other devices to cause a series of operational operations to be executed on the computer, other programmable devices or other devices, so as to produce a computer implemented process, such that the instructions executed on the computer, other programmable devices or other devices implement the functions/actions specified in one or more blocks in the flowchart and/or block diagram.

The flowcharts and block diagrams in the drawings illustrate the architecture, function, and operation that may be implemented by the system, method and computer program product according to the various embodiments of the present disclosure. In this regard, each block in the flowchart or block diagram may represent a module, a program segment, or a part of an instruction, and the module, program segment, or part of an instruction comprises one or more executable instructions for implementing the specified logical function(s). In some alternative implementations, the functions denoted in the blocks may occur in an order different from that denoted in the drawings. For example, two consecutive blocks may, in fact, be executed substantially in parallel, or sometimes they may be executed in a reverse order, depending upon the functions involved. It should also be noted that each block in the block diagram and/or flowchart, and combinations of blocks in the block diagram and/or flowchart, can be implemented by dedicated hardware-based systems performing the specified functions or actions, or by combinations of dedicated hardware and computer instructions.

The computer program product can be implemented by hardware, software, or a combination thereof. In one optional embodiment, the computer program product is specifically implemented as a computer storage medium, and in another optional embodiment, the computer program product is specifically implemented as a software product, such as a Software Development Kit (SDK).

Although the embodiments of the present disclosure have been described above, it will be appreciated that the above descriptions are merely exemplary but not exhaustive, and that the disclosed embodiments are not limiting. A number of variations and modifications, without departing from the scopes and spirits of the described embodiments, are apparent to those skilled in the art. The terms selected in the present disclosure are intend to best explain the principles of the embodiments, practical applications or the technical improvements to the arts in the market, or to make the embodiments described herein understandable to those skilled in the art.

What is claimed is:

1. A target tracking method, comprising:
obtaining a first tracking parameter from a template image of a target object;
tracking the target object in a current image based on the first tracking parameter to obtain a first predicted tracking result of the current image;
determining a second tracking parameter based on the template image and history images of the target object, wherein the history images represent images prior to the current image and containing the target object;
tracking the target object in the current image based on the second tracking parameter to obtain a second predicted tracking result of the current image; and
obtaining a tracking result of the target object in the current image based on the first predicted tracking result and the second predicted tracking result.

2. The method according to claim 1, wherein obtaining the first tracking parameter from the template image of the target object comprises:
extracting a first image feature of the template image as the first tracking parameter.

3. The method according to claim 2, wherein tracking the target object in the current image based on the first tracking parameter to obtain the first predicted tracking result of the current image comprises:
extracting a second image feature of the current image; and
determining the first predicted tracking result of the current image based on the first tracking parameter and the second image feature.

4. The method according to claim 3, wherein
extracting the first image feature of the template image as the first tracking parameter comprises: extracting features of the template image through at least two layers with different depths of a first preset network, to obtain at least two levels of the first image feature of the template image, and taking the at least two levels of the first image feature as the first tracking parameter;
extracting the second image feature of the current image comprises: extracting features of the current image through the at least two layers with different depths to obtain at least two levels of the second image feature of the current image; and
determining the first predicted tracking result of the current image based on the first tracking parameter and the second image feature comprises: for any level of the at least two levels of the first image feature and the at least two levels of the second image feature, determining an intermediate predicted result of the level based on the first and second image features of the level; and based on at least two intermediate predicted results corresponding to the at least two levels of the first image feature and the at least two levels of the second image feature, obtaining the first predicted tracking result of the current image by fusion.

5. The method according to claim 1, wherein determining the second tracking parameter based on the template image and the history images of the target object comprises:
obtaining a third image feature of the template image;
determining an initial second tracking parameter based on the third image feature; and
obtaining an updated second tracking parameter based on the initial second tracking parameter and fourth image features of the history images.

6. The method according to claim 5, wherein,
determining the initial second tracking parameter based on the third image feature comprises: initializing an online module of a second preset network based on the third image feature to obtain the initial second tracking parameter; and
obtaining the updated second tracking parameter based on the initial second tracking parameter and the fourth image features of the history images comprises: inputting the initial second tracking parameter and the fourth image features of the history images into the online module, and obtaining the updated second tracking parameter through the online module.

7. The method according to claim 5, wherein the history images are image areas extracted from history video frames in advance, and probabilities of the history images belonging to the target object are greater than or equal to a first threshold.

8. The method according to claim 5, wherein obtaining the third image feature of the template image comprises:
obtaining at least two levels of the first image feature of the template image and at least two first weights in one-to-one correspondence with the at least two levels of the first image feature; and
determining a weighted sum of the at least two levels of the first image feature based on the at least two first weights to obtain the third image feature of the template image.

9. The method according to claim 1, wherein tracking the target object in the current image based on the second tracking parameter to obtain the second predicted tracking result of the current image comprises:
obtaining a fifth image feature of the current image; and
determining the second predicted tracking result of the current image based on the second tracking parameter and the fifth image feature.

10. The method according to claim 9, wherein obtaining the fifth image feature of the current image comprises:
obtaining at least two levels of the second image feature of the current image and at least two second weights in one-to-one correspondence with the at least two levels of the second image feature; and
determining a weighted sum of the at least two levels of the second image feature based on the at least two second weights to obtain the fifth image feature of the current image.

11. The method according to claim 1, wherein obtaining the tracking result of the target object in the current image based on the first predicted tracking result and the second predicted tracking result comprises:
obtaining a third weight corresponding to the first predicted tracking result and a fourth weight corresponding to the second predicted tracking result;
determining a weighted sum of the first predicted tracking result and the second predicted tracking result based on the third weight and the fourth weight to obtain a third predicted tracking result of the current image; and
determining the tracking result of the target object in the current image based on the third predicted tracking result.

12. The method according to claim 11, wherein determining the tracking result of the target object in the current image based on the third predicted tracking result comprises:
determining a first bounding box with a highest probability of belonging to the target object in the current image, based on the third predicted tracking result;
determining a second bounding box having an overlapping region with the first bounding box in the current image, based on the third predicted tracking result; and
determining a detection box of the target object in the current image based on the first bounding box and the second bounding box.

13. The method according to claim 12, wherein determining the detection box of the target object in the current image based on the first bounding box and the second bounding box comprises:
determining Intersection-over-Union of the second bounding box and the first bounding box;
determining a fifth weight corresponding to the second bounding box, based on the Intersection-over-Union; and
determining a weighted sum of the first bounding box and the second bounding box based on the fifth weight, to obtain the detection box of the target object in the current image.

14. A target tracking device, comprising:
a processor; and
a memory configured to store processor-executable instructions,
wherein the processor is configured to invoke the instructions stored in the memory, so as to:
obtain a first tracking parameter from a template image of a target object;
track the target object in a current image based on the first tracking parameter to obtain a first predicted tracking result of the current image;
determine a second tracking parameter based on the template image and history images of the target object, wherein the history images represent images prior to the current image and containing the target object;
track the target object in the current image based on the second tracking parameter to obtain a second predicted tracking result of the current image; and
obtain a tracking result of the target object in the current image based on the first predicted tracking result and the second predicted tracking result.

15. A non-transitory computer-readable storage medium on which computer program instructions are stored, wherein the computer program instructions, when executed by a processor, causes the processor to carry out a method of:
obtaining a first tracking parameter from a template image of a target object;
tracking the target object in a current image based on the first tracking parameter to obtain a first predicted tracking result of the current image;
determining a second tracking parameter based on the template image and history images of the target object, wherein the history images represent images prior to the current image and containing the target object;
tracking the target object in the current image based on the second tracking parameter to obtain a second predicted tracking result of the current image; and
obtaining a tracking result of the target object in the current image based on the first predicted tracking result and the second predicted tracking result.
